(19) United States
(12) Patent Application Publication
(10) Pub. No.: US 2022/0393215 A1
(43) Pub. Date: Dec. 8, 2022

(54) Fuel Cell, Fuel Cell System and Method for Producing Fuel Cell

(71) Applicant: Hitachi High-Tech Corporation, Minato-ku, Tokyo (JP)

(72) Inventors: Yoshitaka SASAGO, Tokyo (JP); Noriyuki SAKUMA, Tokyo (JP); Yumiko ANZAI, Tokyo (JP); Sonoko MIGITAKA, Tokyo (JP); Natsuki YOKOYAMA, Tokyo (JP); Takashi TSUTSUMI, Tokyo (JP); Aritoshi SUGIMOTO, Tokyo (JP); Toru ARAMAKI, Tokyo (JP)

(21) Appl. No.: 17/770,548

(22) PCT Filed: Nov. 7, 2019
(86) PCT No.: PCT/JP2019/043686

§ 371 Date: Apr. 20, 2022

(51) Int. Cl. H01M 8/1246

(52) U.S. Cl. CPC H01M 8/1246; H01M 8/1004

(57) ABSTRACT

An object of the invention is to increase the output power of a solid oxide fuel cell by making a lower electrode layer porous so as to form a three-phase interface and reducing a thickness of a solid electrolyte layer to 1 micrometer or less. A fuel cell according to the invention includes a first electrode layer at a position where an opening formed in a board is covered, and a solid electrolyte layer having a thickness of 1000 nm or less. At least a part of a region of the first electrode layer covering the opening is porous (see FIG. 5).

### TECHNICAL FIELD

The present invention relates to a solid oxide fuel cell in which a solid electrolyte layer is formed by a film forming process.

### BACKGROUND ART

As a background art in the present technical field, JP-A-2003-59496 (PTL 1) and Journal of Power Sources 194 (2009) 119-129 (NPL 1) are provided.

NPL 1 describes a cell technique for forming an anode layer, a solid electrolyte layer, and a cathode layer of a fuel cell membrane by a thin film forming process. By thinning the solid electrolyte, the ionic conductivity can be improved and the power generation efficiency can be improved. The ionic conductivity of the solid electrolyte shows an activated temperature dependence. Therefore, the ionic conductivity is high at a high temperature and is low at a low temperature. By thinning the solid electrolyte, sufficiently high ionic conductivity can be obtained even at a low temperature, and the practical power generation efficiency can be realized. As the solid electrolyte layer, for example, an yttria stabilized zirconia (YSZ), which is zirconia doped with yttria or the like, is often used. This is because the yttria stabilized zirconia has advantages of excellent chemical stability and a small current due to electrons and holes that cause an internal leakage current of the fuel cell. By using a porous electrode as an anode layer and a cathode layer, a three-phase interface at which a gas, an electrode, and the solid electrolyte are in contact with one another can be enlarged, and power loss due to polarization resistance generated at an electrode interface can be prevented.

There is a problem in the formation of a porous lower electrode. When the solid electrolyte layer is formed on the porous lower electrode, a portion having a thickness smaller than an average film thickness occurs in the solid electrolyte layer due to an influence of the unevenness of the lower electrode serving as a base. Since the pores of the porous lower electrode layer penetrate in a film thickness direction to form the above-described three-phase interface, the unevenness of a surface of the lower electrode substantially corresponds to a film thickness of the lower electrode layer. Therefore, particularly when the thickness of the solid electrolyte layer is substantially reduced to the film thickness of the lower electrode, typically 1 micrometer or less, a portion having a thickness extremely smaller than the average film thickness is formed. When an upper electrode layer is formed on an upper layer of the solid electrolyte layer, a probability of short-circuiting between the upper and lower electrodes via a thin portion of the solid electrolyte layer increases sharply. When a short circuit occurs between the upper and lower electrodes, power cannot be externally output and used when the fuel cell is operating.

NPL 1 discloses a technique in which a solid electrolyte layer is formed on a flat insulating film formed on a substrate, followed by removing the substrate and the insulating film below the solid electrolyte layer, and a porous lower electrode layer is formed from a back surface side of the substrate. When the solid electrolyte layer is formed on the porous lower electrode, a short circuit between the upper and lower electrodes can be avoided by forming a solid electrolyte layer having a sufficient thickness, but the thick solid electrolyte layer causes a decrease in the ionic conductivity and an increase in an internal resistance, and therefore, an increase in power loss, that is, a decrease in output power occurs.

PTL 1 discloses a technique in which a solid electrolyte layer is formed on a lower electrode layer mixed with impurities, and then the mixed impurities are removed by a plasma treatment, a chemical treatment, or the like in a high-temperature oxidizing atmosphere to make the lower electrode layer porous.

### CITATION LIST

### Patent Literature

PTL 1: JP-A-2003-59496

### Non-Patent Literature

NPL 1: Journal of Power Sources 194 (2009) 119-129

### SUMMARY OF INVENTION

### Technical Problem

As described in NPL 1, both the porosification of the lower electrode layer and the thinning of the solid electrolyte layer can be achieved by forming a lower electrode from a back surface of the substrate, but an aperture ratio on a lower electrode side decreases as described later, and thus the output power decreases. Therefore, it is necessary to form the lower electrode layer in a porous form on a side where the solid electrolyte layer of the substrate is formed.

In a method of PTL 1, the solid electrolyte layer is formed after the lower electrode is formed, and then the lower electrode layer is made porous by a high-temperature heat treatment, a plasma treatment, and a chemical treatment. Although no problem occurs at the time of film formation of the solid electrolyte layer, a severe process treatment for the solid electrolyte layer, such as a heat treatment at 1000° C., is required, and therefore, particularly when the thickness of the solid electrolyte layer is reduced to 1 micrometer or less, as the solid electrolyte layer becomes thinner, a probability of occurrence of defects increases. It is necessary to make an electrode porous by a method that does not adversely affect components of a fuel cell, such as a thin film solid electrolyte, an anode layer, and a cathode layer.

The invention has been made in view of the above problems, and an object of the invention is to increase the output power of a solid oxide fuel cell by making a lower electrode layer porous so as to form a three-phase interface, and reducing a thickness of a solid electrolyte layer to 1 micrometer or less.

### Solution to Problem

A fuel cell according to the invention includes a first electrode layer at a position where an opening formed in a board is covered, and a solid electrolyte layer having a thickness of 1000 nm or less. At least a part of a region of the first electrode layer covering the opening is porous.

### Advantageous Effect

According to a fuel cell of the invention, a solid oxide fuel cell that has high power generation efficiency and can operate at a low temperature can be provided. Problems, configurations, and effects other than those described above will be further clarified with the following description of embodiments.

### BRIEF DESCRIPTION OF DRAWINGS

FIG. 1 is a diagram showing a general structure of a fuel cell including a thinned solid electrolyte layer.

FIG. 2 is a schematic diagram showing a configuration example of a fuel cell module using a thin film process type SOFC according to a first embodiment.

FIG. 3 is a view of a partition as viewed from a fuel cell side.

FIG. 4 is a view of the fuel cell as viewed from a back side of the partition.

FIG. 5 is a schematic diagram showing a configuration example of a fuel cell 1 according to the first embodiment.

FIG. 6 is a diagram illustrating an example of a method of forming a porous lower electrode layer 20 shown in FIG. 5.

FIG. 7 is a diagram illustrating the example of the method of forming the porous lower electrode layer 20 shown in FIG. 5.

FIG. 8 is a diagram showing a third variation of a lower electrode material.

FIG. 9 is a diagram showing the third variation of the lower electrode material.

FIG. 10A shows the dependence of a non-defective rate of a fuel cell in the related art and a non-defective rate of the fuel cell 1 according to the first embodiment on the film thickness of a solid electrolyte.

FIG. 10B is a diagram for comparing an effective cell area of the fuel cell 1 according to the first embodiment with an effective cell area in the related art in which a porous electrode is formed from a back surface side of a substrate.

FIG. 11A is a diagram illustrating an effect of the first embodiment.

FIG. 11B is a diagram illustrating a gas supply path in the related art.

FIG. 12 shows an example of a fuel cell according to a second embodiment.

FIG. 13 shows example of the fuel cell according to the second embodiment.

FIG. 14 shows example of the fuel cell according to the second embodiment.

FIG. 15 shows an example of the fuel cell 1 according to a third embodiment.

FIG. 16A shows a part of a manufacturing process of the fuel cell 1 according to the third embodiment.

FIG. 16B shows a part of the manufacturing process of the fuel cell 1 according to the third embodiment.

FIG. 16C shows a part of the manufacturing process of the fuel cell 1 according to the third embodiment.

FIG. 17 is a diagram illustrating an operation of a porous substrate 2.

FIG. 18A shows a configuration example of the fuel cell 1 according to a fourth embodiment.

FIG. 18B is an example in which a porous upper electrode layer 10 is formed on a wiring 11.

FIG. 19 is a configuration example of a fuel cell system according to a fifth embodiment.

### DESCRIPTION OF EMBODIMENTS

Hereinafter, embodiments will be described in detail with reference to the drawings. In all the drawings for illustrating the embodiments, members having the same function are denoted by the same or related reference numerals, and repetitive descriptions thereof are omitted. When a plurality of similar members (parts) are present, symbols may be added to the generic reference numerals to indicate individual or specific portions. In the following embodiments, descriptions of the same or similar portion will not be repeated in principle unless necessary.

In the following embodiments, an X direction, a Y direction, and a Z direction are used as directions for description. The X direction and the Y direction are directions that are orthogonal to each other and constitute a horizontal plane, and the Z direction is a direction perpendicular to the horizontal plane.

In the drawings used in the embodiments, hatching may be omitted even in a cross-sectional view in order to make the drawings easy to see. In addition, hatching may be added even in a plan view so as to make the drawings easy to see.

In the cross-sectional view and the plan view, a size of each part does not correspond to that of an actual device, and a specific part may be displayed in a relatively large size in order to make the drawings easy to understand. Even in a case where the cross-sectional view and the plan view correspond to each other, a specific part may be displayed in a relatively large size in order to make the drawings easy to understand.

### Improvement of Power Generation Efficiency and Lowering of Operating Temperature by Thin Film Process Type Fuel Cell

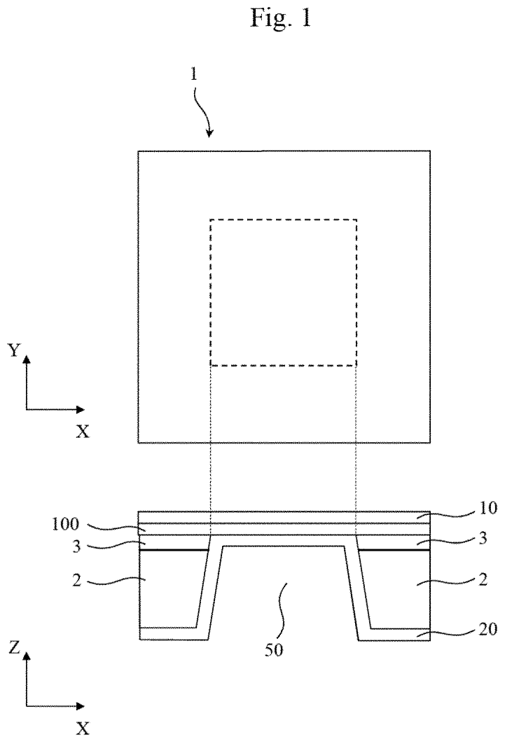

FIG. 1 is a diagram showing a general structure of a fuel cell including a thinned solid electrolyte layer. In order to increase power generation efficiency and realize low-temperature operation, it is necessary to thin a solid electrolyte layer that constitutes a membrane electrode assembly for a fuel cell, and a thin film process type fuel cell in which a solid electrolyte layer is formed in a film forming process is most suitable for the above purpose. When an anode electrode layer, a solid electrolyte layer, and a cathode electrode layer are all thinned, a mechanical strength of the membrane electrode assembly for a fuel cell is weakened, but can be compensated for by substrate support as shown in FIG. 1. For the substrate, for example, silicon, ceramic, glass, metal, or the like can be used. In FIG. 1, a solid electrolyte layer 100 is formed on an insulating film 3 formed on a substrate 2, and an upper electrode layer 10 is formed on the solid electrolyte layer 100. Further, a lower electrode layer 20 is formed from a back surface side of the substrate 2 through an opening 50 formed in the substrate. The upper electrode layer 10 and the lower electrode layer 20 can be formed in a porous form.

### First Embodiment: Configuration of Fuel Cell

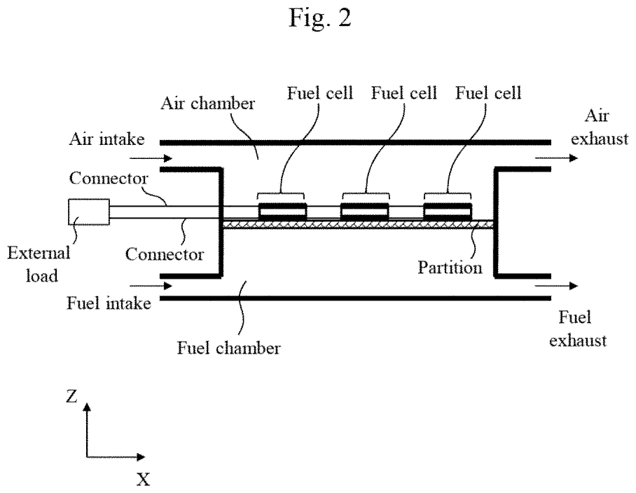

FIG. 2 is a schematic diagram showing a configuration example of a fuel cell module using a thin film process type solid oxide fuel cell (SOFC) according to a first embodiment. A gas flow path in the module is separated into a flow path of a fuel gas and a flow path of a gas (for example, air, the same applies hereinafter) containing an oxygen gas. The flow path of fuel gas includes a fuel intake, a fuel chamber, and a fuel exhaust. The flow path of air includes an air intake, an air chamber, and an air exhaust. The fuel gas and the air are shielded by a partition of FIG. 2 so as not to be mixed in the module. A wiring is led out from the anode electrode and the cathode electrode of the fuel cell by a connector, and is connected to an external load.

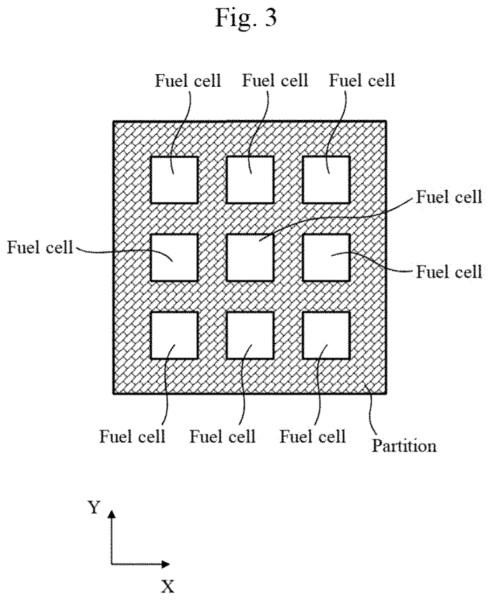

FIG. 3 is a view of a partition as viewed from a fuel cell side. The fuel cell is mounted on the partition. Although one fuel cell may be used, a plurality of fuel cells are generally arranged.

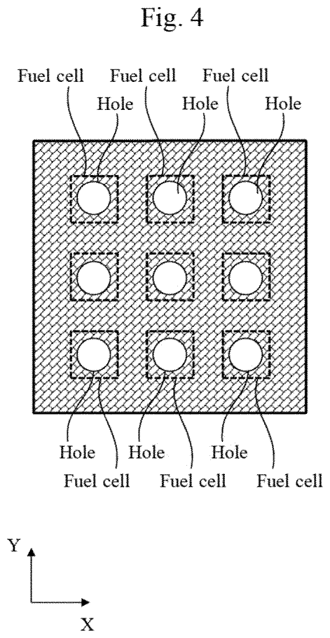

FIG. 4 is a view of the fuel cell as viewed from a back side of the partition. A hole is formed for each fuel cell in the partition so that the fuel gas is supplied to the fuel cell from a fuel chamber.

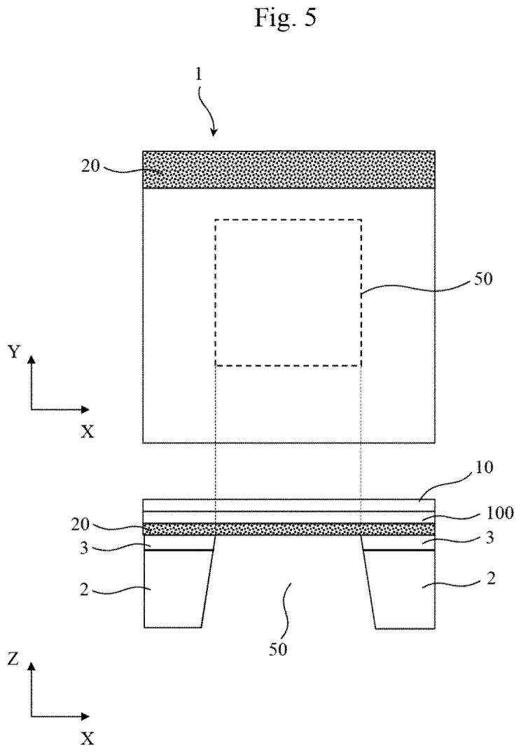

FIG. 5 is a schematic diagram showing a configuration example of a fuel cell 1 according to the first embodiment. The fuel cell 1 corresponds to the fuel cells shown in FIGS. 2 to 4. The insulating film 3 is formed on an upper surface of a silicon substrate 2. The insulating film 3 can be formed of, for example, a silicon oxide film or a silicon nitride film. The opening 50 is formed in a central portion of the silicon substrate 2. The lower electrode layer 20 is formed on an upper layer of the silicon substrate 2 via the insulating film 3. The lower electrode layer 20 can be formed of, for example, platinum. In a state where the fuel cell 1 is completed, the metal constituting the lower electrode layer 20 is made porous. In order to connect the wiring to the lower electrode layer 20, a part of a surface of the lower electrode layer 20 is exposed as shown in FIG. 5.

An yttria-doped zirconia thin film, which is the solid electrolyte layer 100, is formed on an upper layer of the lower electrode layer 20. A doping amount of yttria may be, for example, 3% or 8%. The solid electrolyte layer 100 is formed so as to completely cover the opening 50. The film thickness of the solid electrolyte layer 100 can be, for example, 1000 nm or less by using a technique of the first embodiment. Since YSZ has an extremely small electron current or hole current as an internal leakage current of the fuel cell 1 at a high temperature, the thickness of the solid electrolyte layer 100 may also be reduced to 100 nm or less.

The upper electrode layer 10 is formed on an upper layer of the solid electrolyte layer 100. The upper electrode layer 10 can be formed of, for example, porous platinum.

As described above, a thin film process type fuel cell 1 includes the membrane electrode assembly including the lower electrode layer 20 (platinum), the solid electrolyte layer 100 (polycrystalline YSZ), and the upper electrode layer 10 (platinum) from a lower layer. For example, a fuel gas containing hydrogen is supplied to a lower electrode layer 20 side, and an oxidizing gas such as air is supplied to an upper electrode layer 10 side. A space between the lower electrode layer 20 side and the upper electrode layer 10 side is sealed so that the two kinds of gases to be supplied are not mixed with each other.

### First Embodiment: Method of Forming Lower Electrode

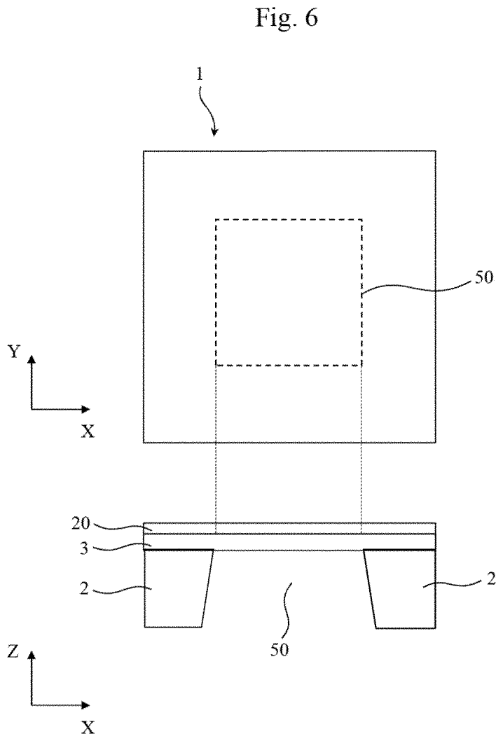

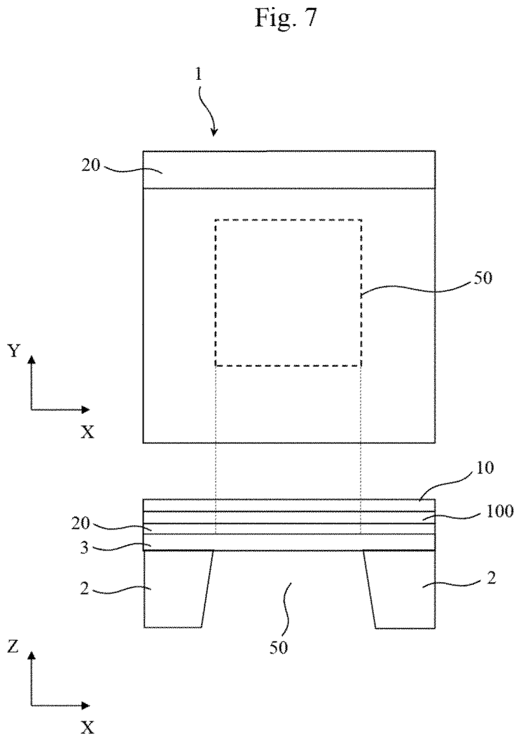

FIGS. 6 and 7 are diagrams illustrating an example of a method of forming the porous lower electrode layer 20 shown in FIG. 5. First, a silicon nitride film 3 is formed on the silicon substrate 2, and a base from which the silicon substrate 2 in a portion to be the opening 50 is removed is prepared. On the silicon nitride film 3 on an upper surface of the silicon substrate 2, platinum oxide (PtO₂) to be the lower electrode layer 20 is formed using, for example, a sputtering method (FIG. 6). A thickness of the platinum oxide layer is, for example, 100 nanometers. The platinum oxide layer immediately after film formation is not porous. Next, the solid electrolyte layer 100 is formed with a film thickness of 1 micrometer or less, for example, a thickness of 100 nanometers. Next, platinum oxide (PtO₂) to be the upper electrode layer 10 is formed using, for example, the sputtering method. A thickness of the platinum oxide layer is, for example, 100 nanometers. The platinum oxide layer immediately after film formation is not porous (FIG. 7).

Next, the silicon nitride film 3 at the opening 50 is removed by, for example, dry etching, and then a heat treatment is performed in the air at about 500° C. With the heat treatment, platinum oxide is reduced and shrinks in volume to become porous platinum. In this way, a structure of FIG. 5 can be obtained by making the lower electrode layer 20 porous.

In the above description, the upper electrode layer 10 is made porous by the same method using the same material as that of the lower electrode layer 20. However, the upper electrode layer 10 is formed on the upper layer of the solid electrolyte layer 100, so that no problem occurs even if the unevenness is present at the time of film formation. Namely, the upper electrode layer 10 may be made porous at the time of film formation.

In the illustration of FIGS. 6 and 7, the silicon substrate 2 in a region of the opening 50 is removed before the formation of the platinum oxide layer to be the lower electrode layer 20, and the silicon substrate 2 in the region of the opening 50 may be removed after the formation of the platinum oxide layer to be the lower electrode layer 20. A reduction heat treatment of changing platinum oxide to platinum is performed after the silicon nitride film 3 at the opening 50 is removed, and the silicon nitride film 3 at the opening 50 may be removed after the reduction heat treatment of changing platinum oxide to platinum is performed.

### First Embodiment: Variations of Lower Electrode Material

The lower electrode layer 20 is formed of porous platinum in the above description, and another material may also be used. A manufacturing process to be used is roughly divided into a method in which an electrode layer is made porous by utilizing the volume contraction due to a reduction treatment of a metal oxide, and a method in which an electrode layer is made porous by utilizing the volume expansion by an oxidation treatment of a metal.

A first variation provides a structure in which the lower electrode layer 20 is formed in a state of nickel oxide, and is subjected to a reduction treatment at about 500° C. after the solid electrolyte layer 100 is formed, and thereby nickel oxide is changed to nickel to make the lower electrode layer 20 porous. The nickel oxide layer is not porous at the time of film formation, but is made porous by the reduction treatment after the solid electrolyte layer 100 is formed. The reduction treatment may also be performed before the upper electrode layer 10 is formed, or may also be performed after the upper electrode layer 10 is formed. In the first variation, other metal oxides such as cobalt oxide, titanium oxide, and iron oxide may also be used instead of nickel oxide. Instead of nickel oxide, for example, a noble metal such as palladium oxide, iridium oxide, ruthenium oxide, and gold oxide may also be used.

A second variation provides a structure in which the lower electrode layer 20 is formed in a state of a mixture of nickel oxide and platinum, and is subjected to a reduction treatment at about 500° C. after the solid electrolyte layer 100 is formed, and thereby nickel oxide in the mixture is changed to nickel to make the lower electrode layer 20 porous. A mixture layer of nickel oxide and platinum is not porous at the time of film formation, but is made porous by the reduction treatment after the solid electrolyte layer 100 is formed. The reduction treatment may also be performed before the upper electrode layer 10 is formed, or may also be performed after the upper electrode layer 10 is formed. In the second variation, a mixture layer of platinum and other metal oxides, such as cobalt oxide, titanium oxide, and iron oxide, instead of nickel oxide may also be used. A mixture layer of platinum and an oxide of a noble metal, such as palladium oxide, iridium oxide, ruthenium oxide, and gold oxide, instead of nickel oxide, may also be used.

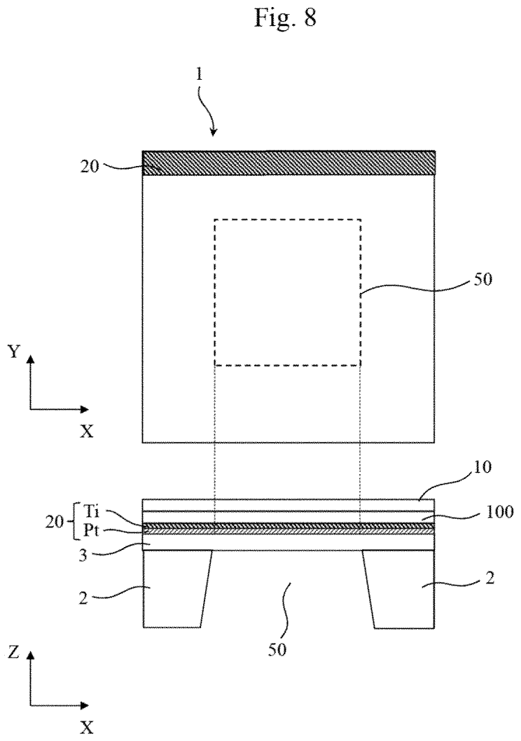

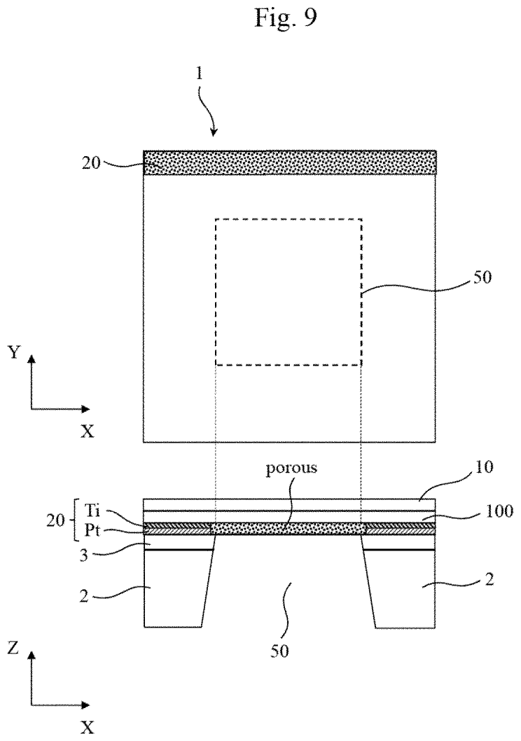

FIGS. 8 and 9 are diagrams showing a third variation. The third variation provides a structure in which the lower electrode layer 20 is formed by laminating a platinum layer and a metallic titanium layer, and is subjected to an oxidation treatment at about 500° C. after the solid electrolyte layer 100 is formed, and thereby the metallic titanium in the laminated film of the platinum layer and the metallic titanium layer is changed to titanium oxide to make the lower electrode layer 20 porous. After a film of platinum is formed on the lower layer, a film of metallic titanium is formed, and the solid electrolyte layer 100 is formed on the metallic titanium (FIG. 8). When metallic titanium is oxidized, metallic titanium expands in volume and enters a grain boundary of platinum, spaces are formed between the platinum and metallic titanium, and the lower electrode layer 20 becomes porous. By performing the oxidation treatment after the silicon nitride film 3 at the opening 50 is removed, the porosification progresses selectively at the opening 50 and an edge portion of the opening 50 (FIG. 9). A laminated film of the platinum layer and the metallic titanium layer is not porous at the time of film formation, but is porous by an oxidation treatment after the formation of the solid electrolyte layer 100. The oxidation treatment may also be performed before the upper electrode layer 10 is formed, or may also be performed after the upper electrode layer 10 is formed. In the third variation, a laminated film of platinum and other metals, such as metallic cobalt, metallic nickel, metallic iron, metallic zirconium, and metallic cerium, instead of metallic titanium may also be used. As in a case of metallic titanium, the other metals form a metal oxide during the oxidation treatment, and expand in volume and enter the grain boundary of platinum, and thereby spaces are formed between platinum and the other metals, and the laminated film becomes porous.

A fourth variation provides a structure in which the lower electrode layer 20 is formed by a mixture layer of platinum and metallic titanium, the solid electrolyte layer 100 is formed, and is subjected to an oxidation treatment at about 500° C. after the solid electrolyte layer 100 is formed, and thereby the metallic titanium in the mixture layer of platinum and metal titanium is changed to titanium oxide to make the lower electrode layer 20 porous. When metallic titanium is oxidized, metallic titanium expands in volume, spaces are formed between platinum and metallic titanium, and the lower electrode layer 20 becomes porous. The mixture layer of platinum and metallic titanium is not porous at the time of film formation, but is porous by the oxidation treatment after the formation of the solid electrolyte layer 100. The oxidation treatment may also be performed before the upper electrode layer 10 is formed, or may also be performed after the upper electrode layer 10 is formed. In the third variation, the laminated film of platinum and other metals, such as metallic cobalt, metallic nickel, metallic iron, metallic zirconium, and metallic cerium, instead of metallic titanium may also be used. As in the case of metallic titanium, the other metals form a metal oxide during the oxidation treatment and expand in volume, spaces are formed between platinum and the other metals, and the mixture layer becomes porous.

In the first to fourth variations, the upper electrode layer 10 may also use a material the same as or different from that of the lower electrode layer 20. Similar to the lower electrode layer 20, the upper electrode layer 10 may also be formed in a non-porous state and made porous by a heat treatment after film formation, or may be formed in a porous state.

### First Embodiment: Effect

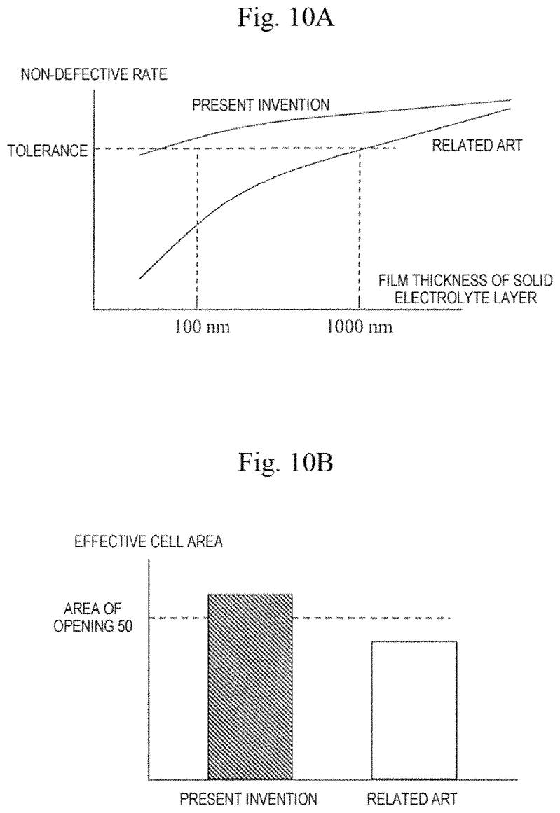

FIG. 10A shows the dependence of a non-defective rate of a fuel cell in the related art and a non-defective rate of the fuel cell 1 according to the first embodiment on the film thickness of a solid electrolyte. As shown in FIG. 10A, the technique of the first embodiment enables thinning of the solid electrolyte film.

FIG. 10B is a diagram for comparing an effective cell area in the fuel cell 1 according to the first embodiment with an effective cell area in the related art in which a porous electrode is formed from a back surface side of a substrate. The areas of the openings 50 are the same. As shown in FIG. 10B, the effective cell area can be increased by using the technique of the first embodiment.

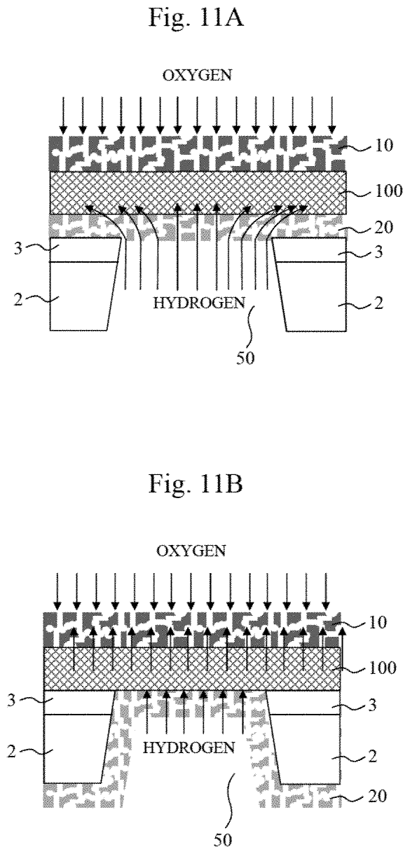

FIG. 11A is a diagram illustrating an effect of the first embodiment. In the structure of the first embodiment, since the porous lower electrode layer 20 is formed on the silicon nitride film 3 on a front surface side of the substrate 2, hydrogen supplied from the lower electrode layer 20 side is transmitted through the porous lower electrode layer 20 in the X direction and the Y direction and is supplied to the solid electrolyte layer 100. Therefore, a region exceeding a range of the area of the opening 50 also contributes to power generation. As a result, in the structure of the first embodiment, the effective cell area is larger than the area of the opening 50. The reason why the effective area exceeding the area of the opening is obtained is that pores of the porous lower electrode layer 20 formed in the first embodiment extend not only in the Z direction (the film thickness direction of the lower electrode layer 20) but also in the X direction and the Y direction (the in-plane direction of the lower electrode layer 20).

FIG. 11B is a diagram illustrating a gas supply path in the related art. In a case of the related art, a solid electrolyte layer is formed on the silicon nitride film 3 on the front surface side of the substrate 2. Therefore, hydrogen that diffuses inside the porous lower electrode layer 20 is supplied to the solid electrolyte layer only in the range of the area of the opening 50. Rather, when the lower electrode layer 20 is thickened at the edge portion of the opening 50, the effective area is smaller than the area of the opening 50.

In the above description, a case where hydrogen is supplied to the lower electrode side and the oxygen is supplied to the upper electrode side has been described, but even when oxygen is supplied to the lower electrode side and hydrogen is supplied to the upper electrode side, the difference occurs similarly in the area of a region to which the gas is supplied on the lower electrode side. Therefore, the effective cell area in the first embodiment is larger than that in the related art.

As described above, in the fuel cell 1 according to the first embodiment, the non-defective rate can be improved as compared with the related art in which the porous lower electrode is formed on the front surface side of the substrate 2, and the effective cell area can be increased as compared with the related art in which the porous lower electrode is formed from the back surface side of the substrate 2.

### Second Embodiment

In the first embodiment, one opening 50 is formed in the substrate 2 as shown in FIG. 5, and it is also possible to divide the opening into a plurality of portions. Actually, when all of the three layers of the anode layer, the solid electrolyte layer, and the cathode layer are formed as thin films, it is difficult to form one opening having a large area because the mechanical strength of these laminated films is weak.

Therefore, as described in NPL 1, for example, it is possible to use the following methods: (a) a method in which a plurality of openings are formed in the substrate 2 by making each opening have a small area; (b) a method in which a large opening 50 is formed in the substrate 2, and the substrate 2 and the insulating film 3 are not completely removed but remain in a grid shape inside the opening 50; and (c) a method in which a large opening 50 is formed in the substrate 2, and electrode wiring for current collection remains in a grid shape on a lower surface of the lower electrode layer 20 inside the opening 50.

Even when the plurality of openings 50 are formed in this way, the porous lower electrode layer 20 is useful. An insulating film is formed on the silicon substrate 2, and the lower electrode layer 20 is formed of platinum oxide (or a material described in any one of variations 1 to 4) in the same manner as in the first embodiment on the insulating film. The lower electrode layer 20 is not porous at the time of film formation, which is the same as in the first embodiment.

After the solid electrolyte layer 100 is formed on the upper layer of the lower electrode layer 20, a plurality of openings are formed, and a heat treatment is performed in the reducing atmosphere or the oxidizing atmosphere to make the lower electrode layer 20 porous as in a case of the first embodiment.

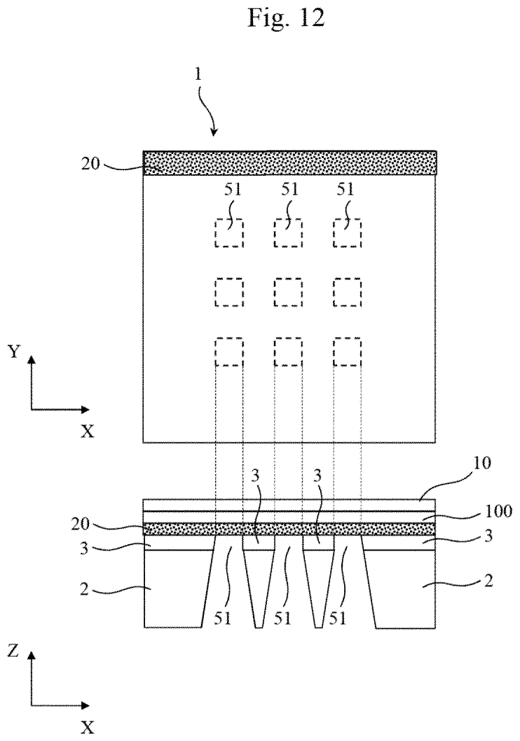

FIG. 12 shows an example of a fuel cell according to the second embodiment. The lower electrode layer 20 and the solid electrolyte layer 100 can be continuously formed over a plurality of openings 51. In FIG. 12, the plurality of openings 51 are formed. Similar to the first embodiment, a part of the surface of the lower electrode layer 20 is exposed as shown in FIG. 12 in order to connect the wiring to the lower electrode layer 20.

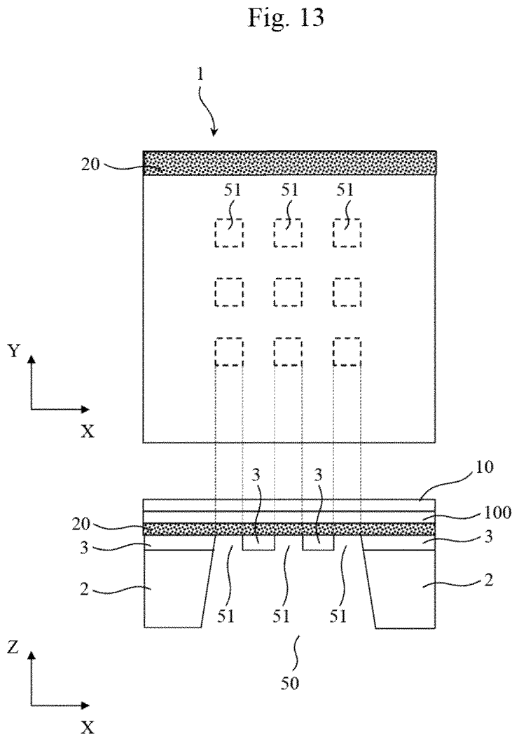

FIG. 13 shows another example of the fuel cell according to the second embodiment. A plurality of small openings 51 may also be formed by partially removing the silicon nitride film 3 inside the opening 50. The openings 51 are separated only by the silicon nitride film 3 in FIG. 13, and the silicon substrate 2 may be partially left under the silicon nitride film. Similar to FIG. 12, a part of the surface of the lower electrode layer 20 is also exposed in FIG. 13 in order to connect the wiring to the lower electrode layer 20.

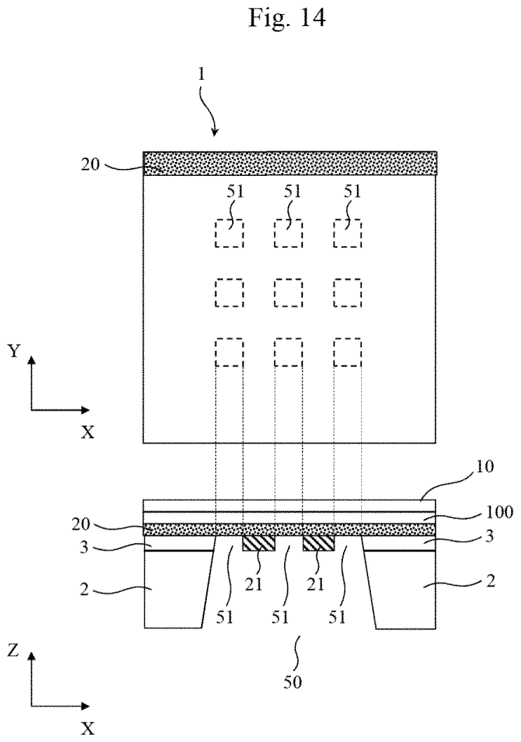

FIG. 14 shows still another example of the fuel cell according to the second embodiment. The silicon nitride film 3 and the silicon substrate 2 between the adjacent openings 51 only have a role of supporting the fuel cell membrane in FIGS. 12 and 13, and as shown in FIG. 14, a lower electrode wiring 21 is formed on a lower surface of the lower electrode layer 20 instead of the silicon nitride film 3 to have both a role of being a collector electrode and the role of supporting the fuel cell membrane.

In the second embodiment, similar to the first embodiment, a high non-defective rate can be maintained as compared with the related art when the solid electrolyte layer 100 is thinned. Since the area of the opening is smaller than that of the first embodiment, the influence of the edge portion is relatively large. Therefore, as compared with the related art in which a porous lower electrode is formed from the back surface of the substrate 2, a ratio of an increase in the effective cell area is increased.

### Third Embodiment

In the first and second embodiments, one or both of the openings 50 and 51 are formed from the back surface side of the substrate 2, and when a porous substrate is used, it is not required to form the opening since the opening is originally formed in the substrate. As the porous substrate, for example, a metal such as nickel and SUS, a semiconductor such as silicon, or an insulator such as alumina and glass can be used.

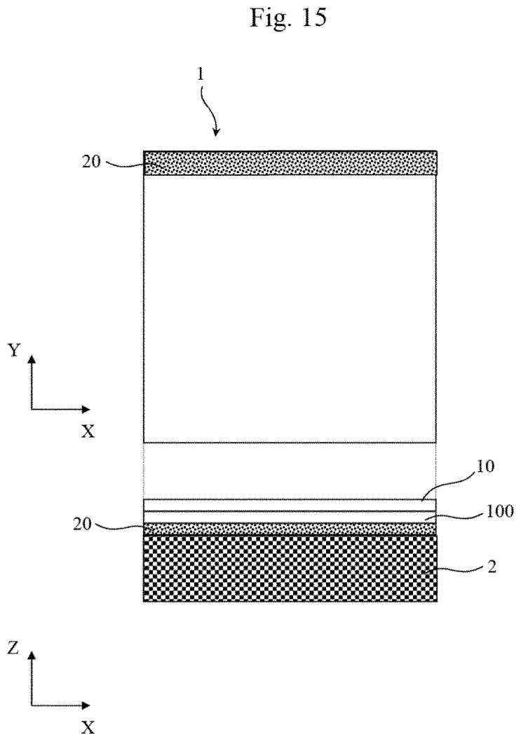

FIG. 15 shows an example of the fuel cell 1 according to a third embodiment. The lower electrode layer 20 is formed on a surface of a porous substrate 2, and the solid electrolyte layer 100 and the upper electrode layer 10 are formed on the upper layer of the lower electrode layer 20. When the porous substrate 2 is formed of an insulator, a part of the lower electrode layer 20 is exposed in order to connect the lower electrode layer 20 and the wiring. When metal is used for the porous substrate 2, the lower electrode layer 20 and the wiring connected to an outside can be electrically connected via the substrate 2, so that an exposed portion on an upper surface side of the lower electrode layer 20 is not required.

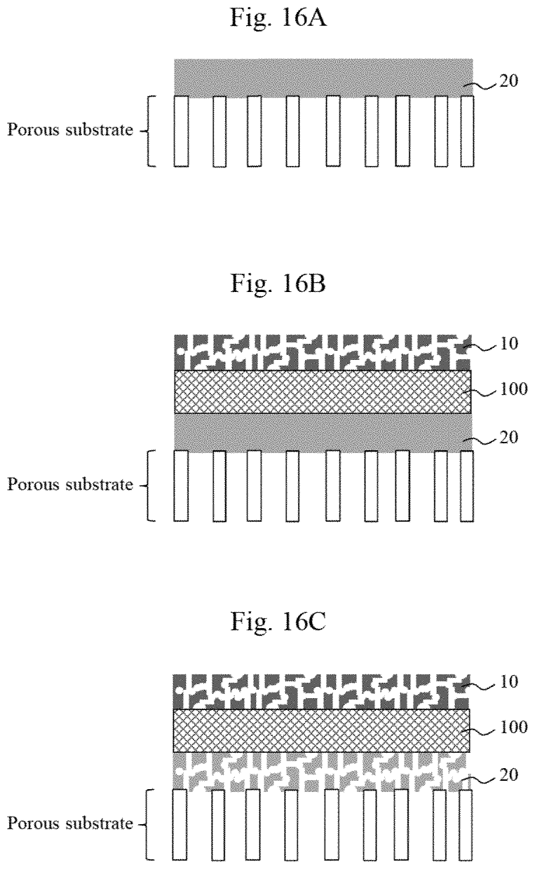

FIGS. 16A to 16C show a part of a manufacturing process of the fuel cell 1 according to the third embodiment. Similar to the first and second embodiments, the lower electrode layer 20 in FIG. 15 is porous at the time of completion, but is not porous at the time of film formation of the solid electrolyte layer 100. The surface of the porous substrate 2 is uneven, but the unevenness of the surface can be greatly reduced by forming the lower electrode layer 20 in a thickness larger than a pore diameter of the porous substrate 2 in the state of, for example, platinum oxide (FIG. 16A). Next, the solid electrolyte layer 100 is formed in a film thickness of 1 micrometer or less, for example, 100 nanometers. Next, the upper electrode layer 10 is formed of porous platinum (FIG. 16B). Next, when annealing is performed at a temperature of about 500° C., the platinum oxide of the lower electrode layer 20 is reduced to shrink in volume and change to porous platinum, similar to the first and second embodiments (FIG. 16C).

In FIGS. 16A to 16C, the solid electrolyte layer 100 is formed after the lower electrode layer 20 is formed of platinum oxide, and the platinum oxide is reduced to form a porous platinum layer, and it is also possible to use the materials of the variations 1 to 4 described in the first embodiment. Similar to the first and second embodiments, the material of the upper electrode layer 10 may be the same as that of the lower electrode layer 20, or another material may be used.

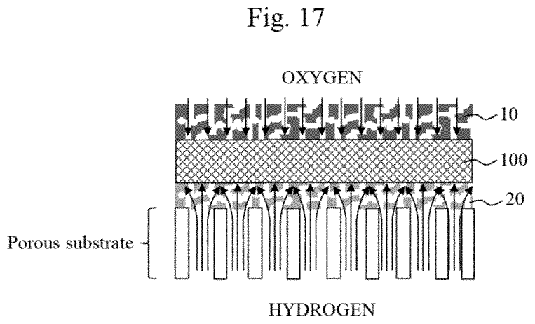

FIG. 17 is a diagram illustrating an operation of the porous substrate 2. In the structure of the third embodiment, a porous lower electrode layer 20 is formed on the surface of the substrate 2. Hydrogen supplied from the lower electrode layer 20 side is transmitted through the porous lower electrode layer 20 in the X direction and the Y direction and is supplied to the solid electrolyte layer 100. Accordingly, a region exceeding a range of the pore area of the porous substrate 2 also contributes to power generation. As a result, an effective cell area in the third embodiment can be made larger than the sum of pore areas of the porous substrate 2. The reason why such an increase in the effective area is obtained is that the pores of the lower electrode layer 20 extend not only in the Z direction (the film thickness direction of the lower electrode layer 20) but also in the X direction and the Y direction (the in-plane direction of the lower electrode layer 20).

In the third embodiment, similar to the first and second embodiments, a high non-defective rate can be maintained as compared with the related art when the solid electrolyte layer 100 is thinned. In the above description, a case where hydrogen is supplied to the lower electrode layer 20 side and oxygen is supplied to the upper electrode layer 10 side has been described, and the same effect can also be obtained in a case where oxygen is supplied to the lower electrode layer 20 side and hydrogen is supplied to the upper electrode layer 10 side.

### Fourth Embodiment

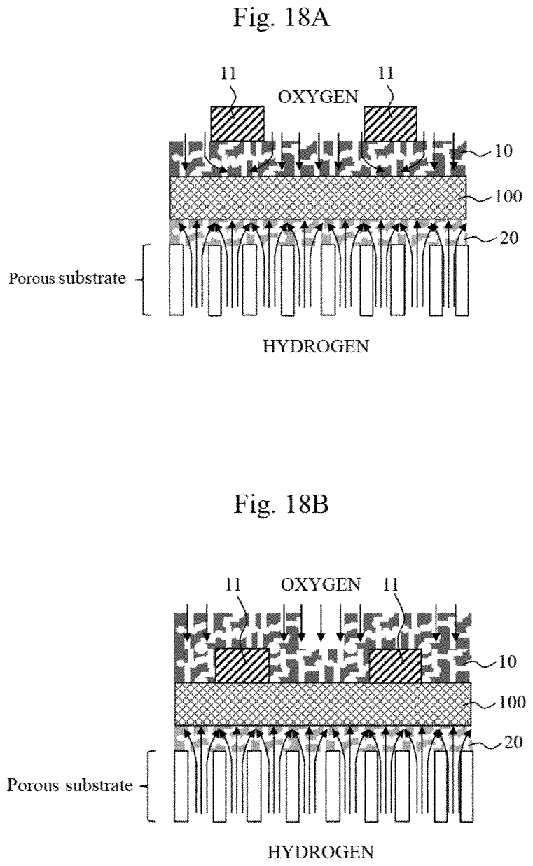

FIG. 18A shows a configuration example of the fuel cell 1 according to a fourth embodiment of the invention. In FIG. 14, the electrode wiring 21 is used for the porous lower electrode layer 20. As the cell area increases, the area of the porous lower electrode layer 20 also increases, and the in-plane resistance increases as the area increases. Therefore, when a current is collected directly from the lower electrode layer 20, the power loss due to the voltage drop increases. In such a case, it is useful to collect the current through the wiring 21 having a resistance smaller than that of the lower electrode layer 20. The same applies not only to the lower electrode layer 20 but also to the upper electrode layer 10. Therefore, in FIG. 18A, a wiring 11 for current collection is provided on an upper surface of the upper electrode layer 10.

When the wiring 21 is used as shown in FIG. 14, the power loss of the lower electrode layer 20 can be avoided. Further, by forming the wiring 11 on an upper layer of the upper electrode layer 10, the power loss of the upper electrode layer 10 can be prevented. At this time, it is desirable that the porous upper electrode layer 10 is formed between the wiring 11 and the solid electrolyte layer 100 (FIG. 18A). Accordingly, the oxygen gas diffuses to a lower portion of the wiring 11 via the porous upper electrode layer 10, so that a portion covered with the wiring 11 can also contribute to power generation.

FIG. 18B is an example in which the porous upper electrode layer 10 is formed on the wiring 11. Also in a configuration of FIG. 18B, the power loss of the upper electrode layer 10 can be prevented, but the area contributing to power generation is smaller than that of FIG. 18A.

In the above description, the case where hydrogen is supplied to the lower electrode layer 20 side and oxygen is supplied to the upper electrode layer 10 side has been described, but the same effect as that illustrated with reference to FIG. 18A can also be obtained in the case where oxygen is supplied to the lower electrode layer 20 side and hydrogen is supplied to the upper electrode layer 10 side.

### Fifth Embodiment

Unlike FIG. 2, a mixed gas of a fuel gas containing hydrogen and a gas containing oxygen such as air may be supplied to the entire fuel cell 1. In this case, the same mixed gas is supplied to the lower electrode layer 20 and the upper electrode layer 10, but the shapes of the electrodes are different, so that a potential difference is generated to generate power. An electromotive force can be increased by changing an electrode material between the lower electrode layer 20 and the upper electrode layer 10.

Such a fuel cell is called a single-chamber fuel cell. The single-chamber fuel cell has an advantage that the structure can be simplified and a system cost can be reduced because it is not necessary to separate and seal a gas system containing a fuel gas and a gas system containing an oxidizing agent such as oxygen. In the fifth embodiment of the invention, a configuration example in which a fuel cell system including the fuel cell 1 is the single chamber type will be described.

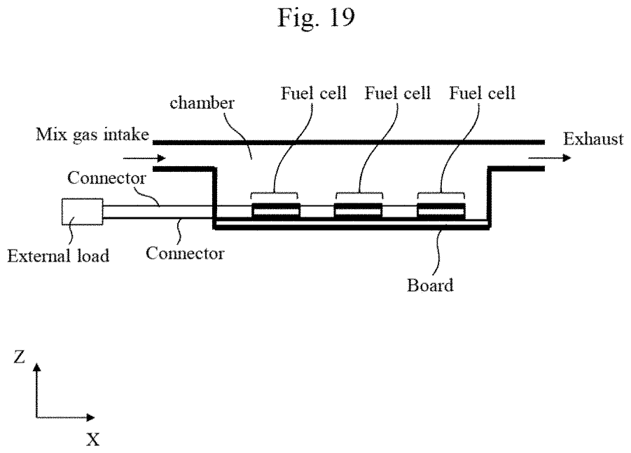

FIG. 19 is a configuration example of the fuel cell system according to the fifth embodiment. The gas introduced into the module is a mixed gas of oxygen and a fuel gas, and the mixed gas flows along a mix gas intake, a chamber, and an exhaust. The wiring is led out from the anode electrode and the cathode electrode of the fuel cell, and is connected to the external load by the connector. The fuel cell is mounted on a board. One fuel cell may be used, and a plurality of fuel cells are generally arranged. The fuel cell according to the first to fourth embodiments can be used for the fuel cell of FIG. 19.

### Modification of Invention

The invention is not limited to the embodiments described above, and includes various modifications. For example, the embodiments described above have been described in detail for easily understanding the invention, and the invention is not necessarily limited to those including all the configurations described above. A part of the configuration of one embodiment can be replaced with the configuration of another embodiment, and the configuration of another embodiment can be added to the configuration of one embodiment. In addition, a part of the configuration of each embodiment can be added, deleted, or replaced with other configurations.

### Reference Sign List

1 fuel cell

2 substrate

3 insulating film

10 upper electrode layer

20 lower electrode layer

11 current collector wiring

12 current collector wiring

50 opening

51 opening

100 solid electrolyte layer

1. to 15. (canceled)

16. A fuel cell, comprising:
a board that includes an opening;
a first electrode layer that is disposed on the board and covers the opening;
a solid electrolyte layer that is disposed on the first electrode layer and has a thickness of 1000 nm or less; and
a second electrode layer that is disposed on the solid electrolyte layer, wherein
at least a part of a portion of the first electrode layer that covers the opening has a porous structure,
at least a part of a portion of the first electrode layer other than the portion that covers the opening has a non-porous structure,
the porous structure is made of an oxide of a metal, and the non-porous structure is made of a non-oxide of the same metal, or
the porous structure is made of a non-oxide of a metal, and the non-porous structure is made of an oxide of the same metal.

17. The fuel cell according to claim 16, wherein
the porous structure has a plurality of pores along a film thickness direction of the first electrode layer and a plurality of pores along an in-plane direction of the first electrode layer.

18. The fuel cell according to claim 16, wherein
the first electrode layer is formed of at least one of a porous platinum layer, a porous nickel layer, a porous cobalt layer, a porous titanium layer, a porous iron layer, a porous palladium layer, a porous iridium layer, a porous ruthenium layer, and a porous gold layer.

19. The fuel cell according to claim 16, wherein
the first electrode layer is formed of a mixed material of platinum and a base metal or a mixed material of platinum and a noble metal,
a portion of the first electrode layer formed of the base metal and a portion of the first electrode layer formed of the noble metal have pores forming the porous structure,
the base metal is at least one of nickel, cobalt, titanium, and iron, and
the noble metal is at least one of palladium, iridium, ruthenium, and gold.

20. The fuel cell according to claim 16, wherein
the first electrode layer includes a platinum layer, a metal layer, and the porous structure,
the porous structure is formed in a region that covers the opening,
the porous structure is formed of a mixed material of platinum and an oxide of the metal, and
the metal is at least one of titanium, cobalt, nickel, iron, zirconium, and cerium.

21. The fuel cell according to claim 16, wherein
the first electrode layer is formed of a mixed material of platinum and a metal,
the porous structure is formed in a region that covers the opening,
the porous structure is formed of a mixed material of platinum and an oxide of the metal, and
the metal is at least one of titanium, cobalt, nickel, iron, zirconium, and cerium.

22. The fuel cell according to claim 16, further comprising
an insulating layer disposed between the board and the solid electrolyte layer, wherein
the opening is divided into a plurality of sections by the insulating layer.

23. The fuel cell according to claim 16, further comprising
a wiring in contact with the first electrode layer, wherein
the opening is divided into a plurality of sections by the wiring.

24. The fuel cell according to claim 16, wherein
the board is a porous substrate having pores,
the porous substrate is formed by using at least one of a porous metal substrate, a porous ceramic substrate, and a porous semiconductor substrate, and
the opening is formed by the pores.

25. The fuel cell according to claim 16, further comprising
a wiring disposed on a surface of the second electrode layer on a side that is not in contact with the solid electrolyte layer, wherein
the second electrode layer has a porous structure.

26. The fuel cell according to claim 16, wherein
a film thickness of the solid electrolyte layer is smaller than a film thickness of the first electrode layer.

27. A fuel cell system, comprising:
the fuel cell according to claim 16;
a supply port through which a gas is supplied to the fuel cell, and
a discharge port through which the gas is discharged.

28. A method of manufacturing a fuel cell, comprising:
a step of forming a first electrode layer on a board;
a step of forming a solid electrolyte layer of 1000 nm or less on the first electrode layer;
a step of forming a second electrode layer on the solid electrolyte layer;
a step of exposing a lower surface of the first electrode layer by forming an opening on the lower surface of the first electrode layer after forming the solid electrolyte layer; and
a step of making the first electrode layer porous in a region where the lower surface is exposed from the opening by heat-treating the first electrode layer in an oxidizing atmosphere or a reducing atmosphere, and leaving the first electrode layer as it is without making the first electrode layer porous in a region where the lower surface is not exposed.

29. The method of manufacturing the fuel cell according to claim 28, wherein
in the step of forming the first electrode layer,
the first electrode layer is formed by forming a film of a material containing at least one of platinum oxide, nickel oxide, cobalt oxide, titanium oxide, iron oxide, palladium oxide, iridium oxide, ruthenium oxide, and gold oxide, or
the first electrode layer is formed by forming a film of a material containing at least one of a mixture of platinum and nickel oxide, a mixture of platinum and cobalt oxide, a mixture of platinum and titanium oxide, a mixture of platinum and iron oxide, a mixture of platinum and palladium oxide, a mixture of platinum and iridium oxide, a mixture of platinum and ruthenium oxide, and a mixture of platinum and gold oxide, and
in the step of forming the porous structure,
the porous structure is formed by heat-treating the first electrode layer in the reducing atmosphere to reduce an oxide in the first electrode layer.

30. The method of manufacturing the fuel cell according to claim 28, wherein
in the step of forming the first electrode layer,
the first electrode layer is formed by forming at least one of a platinum layer and a titanium layer, a platinum layer and a cobalt layer, a platinum layer and a nickel layer, a platinum layer and an iron layer, a platinum layer and a zirconium layer, and a platinum layer and a cerium layer, or
the first electrode layer is formed by forming at least one of a mixed material of platinum and titanium, a mixed material of platinum and cobalt, a mixed material of platinum and nickel, a mixed material of platinum and iron, a mixed material of platinum and zirconium, and a mixed material of platinum and cerium, and
in the step of forming the porous structure,
the porous structure is formed by heat-treating the first electrode layer in the oxidizing atmosphere to oxidize the metal in the first electrode layer.
